(19) United States
(12) Patent Application Publication
(10) Pub. No.: US 2025/0232319 A1
(43) Pub. Date: Jul. 17, 2025

(54) SYSTEM AND METHOD FOR IMPROVED ANTI-COUNTERFEITING USING A QR CODE WITH EMBEDDED NFT

(71) Applicants: John Bao NGUYEN, Grand Prairie, TX (US); Todd Allen KEITEL, Weatherford, TX (US)

(72) Inventors: John Bao NGUYEN, Grand Prairie, TX (US); Todd Allen KEITEL, Weatherford, TX (US)

(21) Appl. No.: 18/929,243

(22) Filed: Oct. 28, 2024

Related U.S. Application Data
(60) Provisional application No. 63/546,070, filed on Oct. 27, 2023.
(60) Provisional application No. 63/681,318, filed on Aug. 9, 2024.

(51) Int. Cl. G06Q 30/018; G06K 19/06

(52) U.S. Cl. CPC G06Q 30/0185; G06K 19/06037

(57) ABSTRACT

Each luxury item is provided with a unique indicium that is formed by a QR code with an embedded NFT. The NFT is minted and stored using blockchain technology. The indicia thus provide both the benefit of being easily scanned and the uniqueness that cannot be reproduced without detection. The indicium is attached to each item, whether by a permanent or non-permanent tag. In some instances, the indicia can be embedded into the surface ornamentation of the item. During the initial sale of the item, the indicia is scanned, and ownership of the item updated in the blockchain. During subsequent transactions of the same item, the indicia can be scanned again thus allowing the authenticity of the good to be verified and the ownership updated. The indicia can be created by the manufacturer of the goods or by a third party.

### CROSS REFERENCE TO RELATED APPLICATION

This application claims the benefit of provisional U.S. Application No. 63/546,070 filed on Oct. 27, 2023, and provisional U.S. Application No. 63/681,318 filed on Aug. 9, 2024, the technical disclosure of both of which are incorporated herein by reference in their entirety.

### TECHNICAL FIELD

The present disclosure relates to systems and methods for the authentication of a product's provenance. A unique QR code is created for the individual item and that QR code is nested within an NFT to create an indicium. This indicium can be placed on a hang tag for an item or printed onto the surface of the product, or otherwise coupled to the individual product. A non-fungible authentication architecture allows for the provenance to be stored and retrieved.

### DESCRIPTION OF RELATED ART

Expensive consumer goods are common targets for counterfeiting. For example, a Rolex brand watch or a Louis Vuitton brand purse each cost many thousands of dollars to purchase. However, almost identical counterfeit copies might only cost several hundred dollars. And while counterfeit goods such as these can be legally confiscated, the brand value of Rolex and Louis Vuitton is damaged by the low-cost copies in the marketplace. A need exists for allowing consumers to differentiate between the real and the fake luxury goods. A need also exists for shop owners and brand owners to easily differentiate the fake goods from the real while also determining a chain of title for the goods

Simple holograms have been used on hang tags for many years to indicate a genuine product. A consumer seeing the special hologram on the hang tag could deduce that the goods were genuine or authorized by the brand owner. However, counterfeiters are now able to easily reproduce the holograms as well.

Likewise, there are visual quality cues that are available. Authentic Louis Vuitton bags include a stamp that says “Louis Vuitton” and “made in France” (or another country) imprinted in the leather. The stamp should have specific features such as a short leg at the bottom of the Ls, round Os larger than the Ls, Ts that appear to be touching, and thin and crisp lettering. Additionally, the pattern on the bag should be a mirror image of itself going across the bag, with no cutoffs or crookedness. Again, a well-trained counterfeiter is capable of achieving the same look.

Goods in the marketplace also need to have an easy method of identifying the specific SKU or item number for the product for inventory control. A QR code or UPC code allows a store to quickly scan the item and retrieve its price and also update inventory records. A QR code (short for “quick-response code”) is a type of two-dimensional matrix barcode, invented in 1994, by Japanese company Denso Wave for labelling automobile parts. A barcode is a machine-readable optical image that contains information specific to the labelled item. In practice, QR codes contain data for a locator, an identifier, and web tracking. To efficiently store data, QR codes use four standardized modes of encoding (i) numeric, (ii) alphanumeric, (iii) byte or binary, and (iv) kanji.

A QR code consists of black squares arranged in a square grid on a white background, including some fiducial markers, which can be read by an imaging device such as a camera, and processed using Reed-Solomon error correction until the image can be appropriately interpreted. The required data is then extracted from patterns that are present in both horizontal and vertical components of the image.

A non-fungible token, or NFT, is a unique digital identifier that is recorded on a blockchain and is used to certify ownership and authenticity. It cannot be copied, substituted, or subdivided. The ownership of an NFT is recorded in the blockchain and can be transferred by the owner, allowing NFTs to be sold and traded. NFTs can be created by anybody and require few or no coding skills to create. NFTs typically contain references to digital files such as artworks, photos, videos, and audio. Because NFTs are uniquely identifiable, they differ from cryptocurrencies, which are fungible.

Proponents claim that NFTs provide a public certificate of authenticity or proof of ownership. The ownership of an NFT as defined by the blockchain has no inherent legal meaning and does not necessarily grant copyright, intellectual property rights, or other legal rights over its associated digital file. An NFT does not restrict the sharing or copying of its associated digital file and does not prevent the creation of NFTs that reference identical files. Still, the unique nature of an NFT ensures that if a duplicate is created, it is quickly detected as a duplicate to an earlier minted NFT.

Others have attempted to incorporate a QR codes onto goods. Published PCT Application WO 2022/217261 A1 is related to use of a QR code for information transfer related to an article, item or product. The QR code links a potential buyer to information related to the origin of the item. In one embodiment, the company logo is added to the QR code. As shown in FIG. 1, a shirt is shown with a depiction 120, a logo 130 and a QR code 100. Thus, a consumer can scan the QR code and obtain more information directed to an item's provenance and authenticity. However, this still does not prevent a clever counterfeiter from spoofing a new website that is linked to a QR code on its counterfeit goods.

A need exists for a method of embedding an NFT onto a QR code, wherein the NFT would be impossible to reproduce without triggering a record of its duplication on the blockchain. Such a NFT/QR code combination could be printed directly on the goods or on to tags associated with the goods. A system for minting, distribution and tracking could be handled by the manufacturer of the goods or by a third party.

### BRIEF SUMMARY

The current invention addresses a system designed for the verification of authentic, luxury goods. Specifically, it provides a system for scanning QR Codes which have been embedded into a unique NFT and allows for the potential consumer to verify if a product is authentic as well as if the distributor or seller is legitimate. The NFT is minted, and its initial ownership is established with the manufacturer and recorded on the blockchain.

A QR code is then generated for the item. AI-generated QR codes are created using machine learning algorithms and computer vision techniques. To make AI-generated QR codes, you need to follow these steps: 1. Collect a dataset of existing QR codes and preprocess them for training. 2. Train a generative model, such as Stable Diffusion ControlNet, to learn the patterns and features of QR codes. 3. Generate new QR codes using the trained model and fine-tune and optimize them for readability and quality. 4. Use free tools on Google Collab or Hugging Face Spaces to create and download your custom AI QR codes. Please note that AI-generated QR codes are unique and artistic designs created by an AI model. They are not the same as traditional QR codes.

The process of minting the NFT and creating the “indicia” can be provided as a service, similar to the services of GS1 and UPC codes. GS1 creates a unique UPC code for every item sold by a GS1 subscriber. That UPC code is placed on the item. For instance, every twelve-ounce Coca-Cola sold individually in an aluminum can in the United States might have an identical UPC code. This allows the scanning of the UPC code at a check-out to retrieve the price of that can of soda. In other words, a single UPC code is placed onto millions of cans.

In contrast, this method creates a singularly unique indicia that is placed onto a singular item. Each Louis Vuitton purse will have its own unique indicia made up of a QR code embedded into an NFT. That unique indicia will provide more than simple inventory and pricing information. It will now be permanently linked to that single unique purse. To further clarify, if Louis Vuitton makes 5000 identical purses, for example its Pochette Metis model M44875, each individual purse will have its own unique NFT/QR code associated with it and stored on the blockchain.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a prior art illustration showing the use of a QR code embedded with a static logo.

FIG. 2 is an example of a QR code embedded into a unique NFT per the current invention

FIGS. 3A and 3B are block diagrams showing the basic steps in the method per the current invention.

FIG. 4 is another example of an NFT embedded into a QR code.

FIG. 5 is another example of an NFT embedded into a QR code, wherein the indicium includes additional advertising text.

FIG. 6 is a flow diagram representing the NFT embedded with a QR Code on the manufacturer/distributor end.

FIGS. 7A and 7B are flow diagrams representing the text to image generation pipeline and image to image generation pipeline respectively.

FIG. 8 represents the encoding and decoding process in relation to embedding the NFT and QR Code.

FIG. 9 is an example of images through the various steps of the encoding process.

FIG. 10 is a flow diagram representing the non-fungible authentication architecture.

FIG. 11 is a flow diagram representing the process for the validation of a product using the associated NFT.

FIG. 12 is a flow diagram representing the sequence of events for an online or in person purchase of a good.

FIG. 13 is a flow diagram representing the sequence of events for a brick-and-mortar purchase of a good.

FIG. 14 is a flow diagram representing the process of authenticating a distributor or dealer of goods.

FIGS. 15A-15C provide an alternative method of embedding the QR code into an NFT and reversibly allowing it to be extracted therefrom.

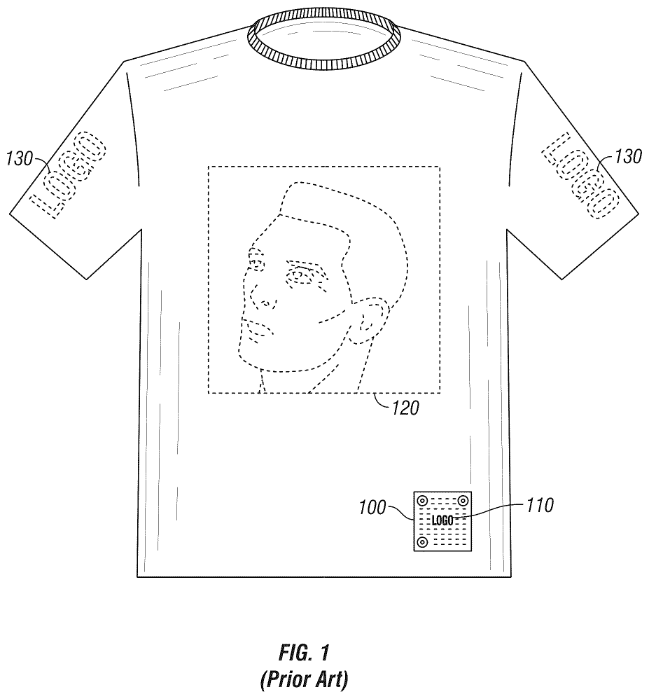

### DETAILED DESCRIPTION

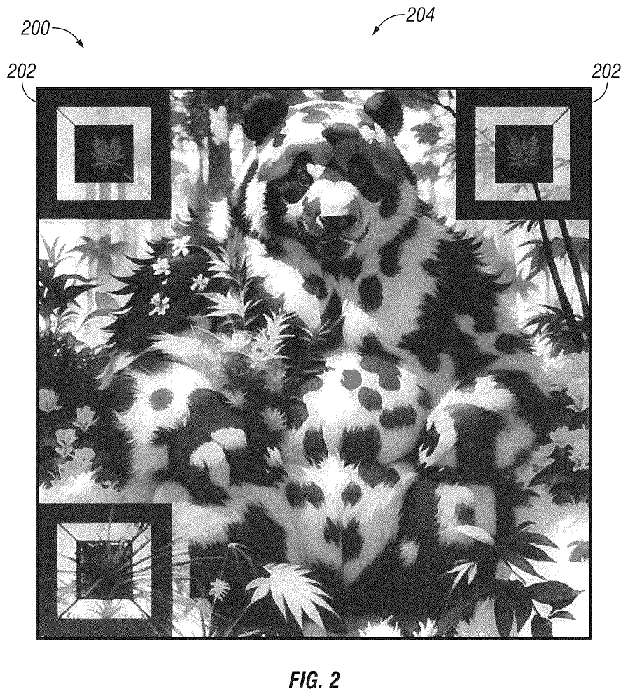

Embodiments of the disclosure will now be described. FIG. 2 illustrates an indicium 200 having a QR code 202 with an embedded NFT 204. The QR code can still be scanned. Registration marks 202 are still visible to a scanner, such as a mobile phone. However, the additional elements of the QR code are masked within an NFT of a panda bear 204. NFT 204 is absolutely unique, and this indicium will only be used one time on a single item. The NFT is minted in the traditional fashion and its initial owner will be the manufacturer of the good. However, the process of designing and minting the NFT can be outsourced to a third-party provider. Likewise, the NFT can be produced by a digital artist or by artificial intelligence. AI generated NFTs can be mass produced and would automatically come with the necessary meta data in order to capture creation dates, colors, shapes and so forth.

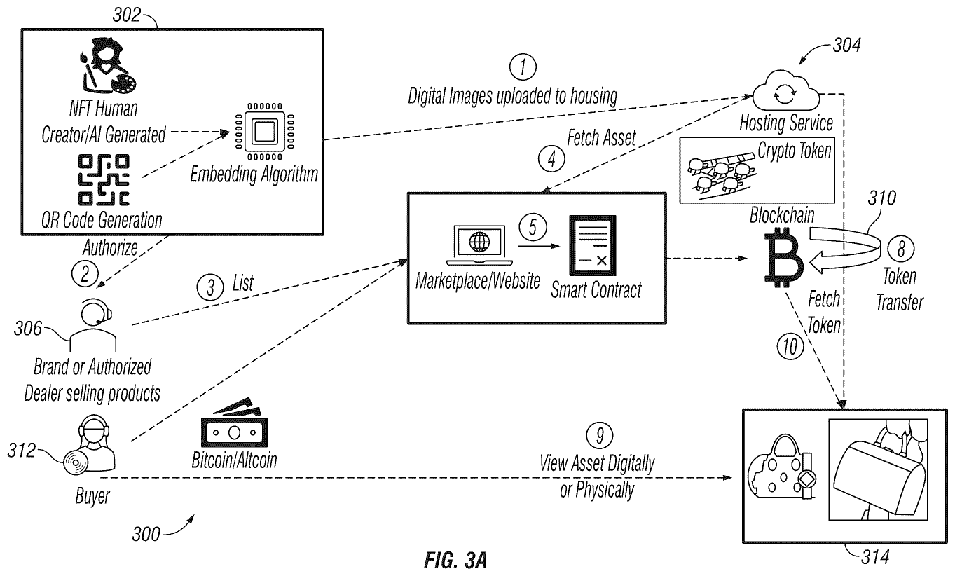

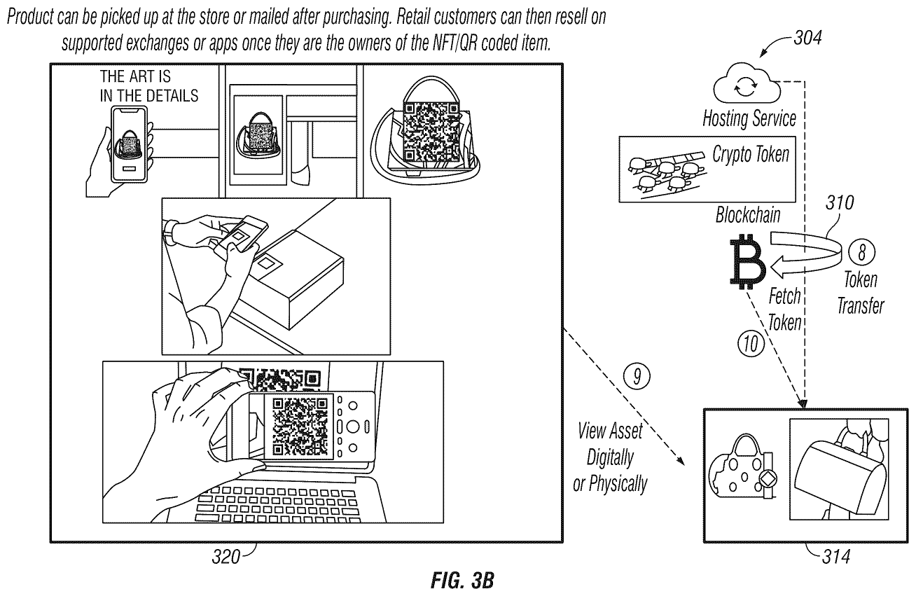

FIG. 3A provides a block diagram of process 300. As a first step, the NFT is created 302. It can be generated by a talented human artist or a graphic designer or an AI code. That NFT is then embedded with a QR code using an embedding algorithm to create the “indicium.” The digital artwork of the indicium is uploaded to a hosting site 304. It is also shared with the brand owner 306 to be used on the specific item. The item can be sold in a store or over a website 308. A smart contract can be affiliated with the item and its unique indicia. A bid can be received from a potential buyer 312 of the item. Customers must purchase the item with cryptocurrency after converting it from fiat currency. This will allow the verification of the customer and tethering their cryptocurrency transactions 310 with the NFT/QR Code. The asset can then be viewed physically or digitally 314.

FIG. 3B provides some additional details on the subsequent sale of goods that incorporate the indicia. If the luxury item is placed for sale on a website, a potential buyer can use a cell phone camera with an appropriate application for reading QR codes. The website should provide an image of the indicia thus allowing the user to scan it with the cell phone app. This will lead the potential buyer to information confirming the authenticity of the goods.

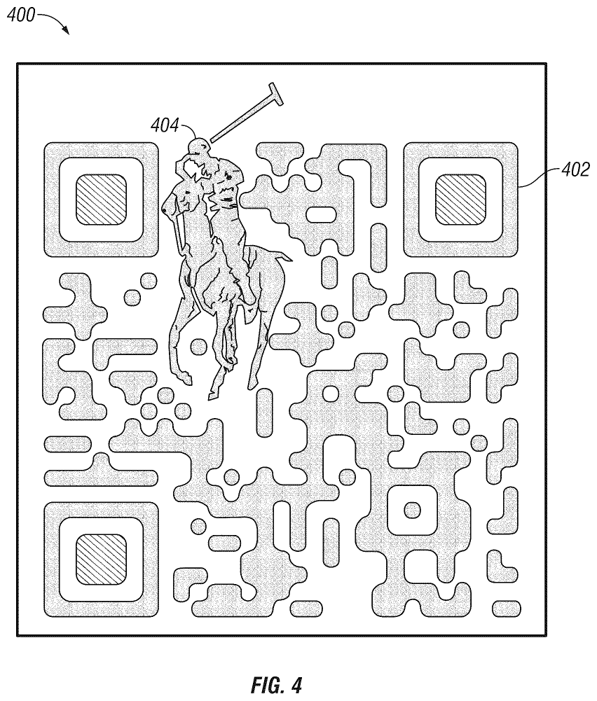

FIG. 4 illustrates an indicium 400 having a QR code 402 with an embedded NFT 404. In the non-limiting embodiment illustrated in FIG. 4, the NFT 404 may include a trademark associated with the good.

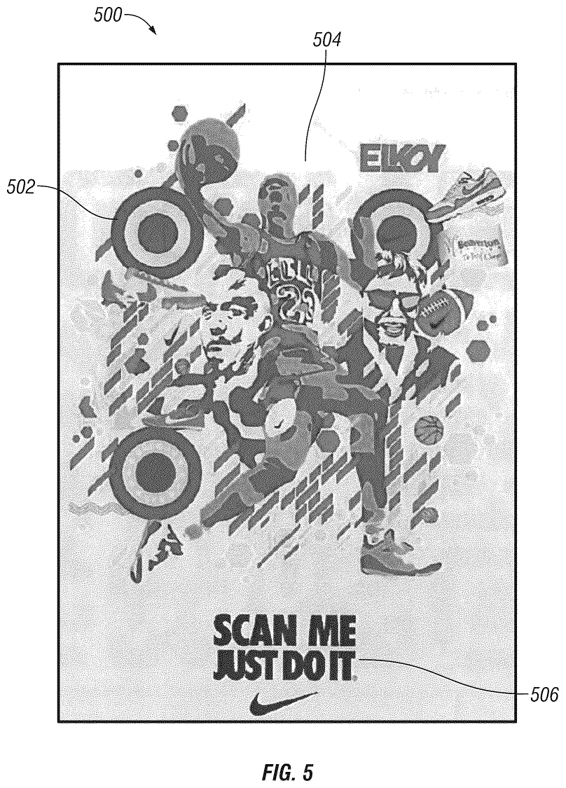

FIG. 5 illustrates an indicium 500 having a QR code 502 with an embedded NFT 504. As previously described, the NFT 504 may include a trademark associated with the good. The indicium 500 may also include text 506 comprising trademarked words or phrases associated with the good.

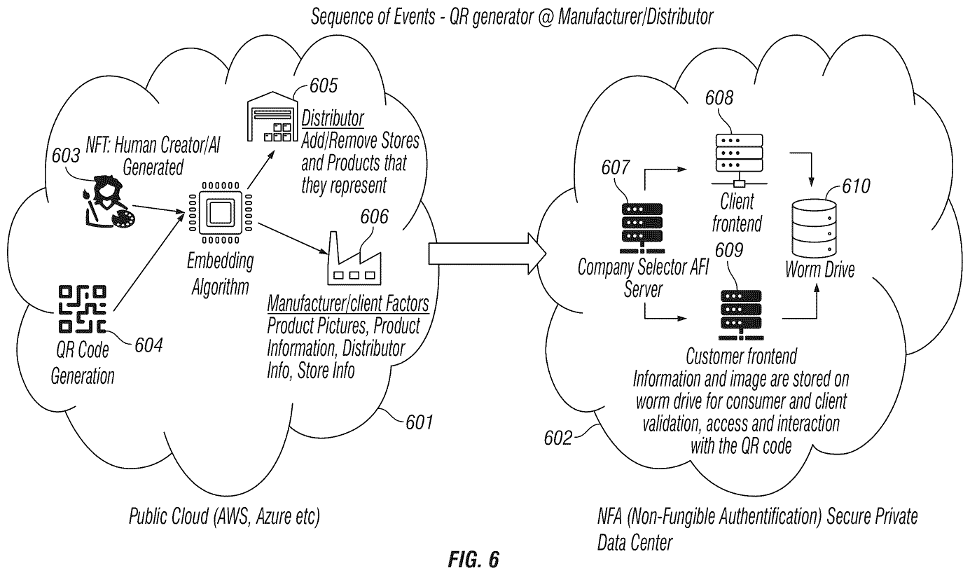

FIG. 6 illustrated the sequence of events from the generation of the combined NFT and QR code to the delivery of the said code to the manufacturer. For this process, there are two distinct locations wherein the functional steps are taken, the Public Cloud 601 and the NFA (Non-Fungible Authentication) Secure Private Data Center 602. During a first step in the Public Cloud 601, the NFT is created by either a human or AI generator 603. Further, a separate QR code is created 604. The NFT 603 and the QR code 604 are then sent into an embedding algorithm in which the NFT becomes embedded with the QR code, creating the indicium. This indicium is then sent to the manufacturer 606 and the distributor 605. The manufacturer 606 adds product pictures, product information, distributor information, and store information in association with the indicium. The distributor 605 adds or removes stores and products which they represent. The indicium is then sent to the NFA Secure Private Data Center 602 where the indicium goes through the Company Selector API server 607. Then the indicium goes through either a client front end 608 or a customer front end 609, after which the indicium becomes stored in the worm drive 610. The worm drive 610 stores information and the image for consumer and client validation, as well as controls access and interaction with the indicium.

In the event that the indicium has been unlawfully copied and affiliated with a counterfeit good, the counterfeit copy will be detected by the worm (write once, read many) drive. The worm drive 610 allows for the storage of the NFT data on the blockchain. However, the worm drive 610 will also detect if another instance of the same NFT is created on the blockchain. For instance, if a counterfeiter copies the NFT and QR code perfectly, the scanning of the code will not allow for another instance of that specific good to be written onto the blockchain. Once a counterfeit is detected, the brand owner or the third-party service provider can record the findings. The subsequent action will ultimately be determined by the brand owner or service provider to pursue recourse in verification of the authentic product.

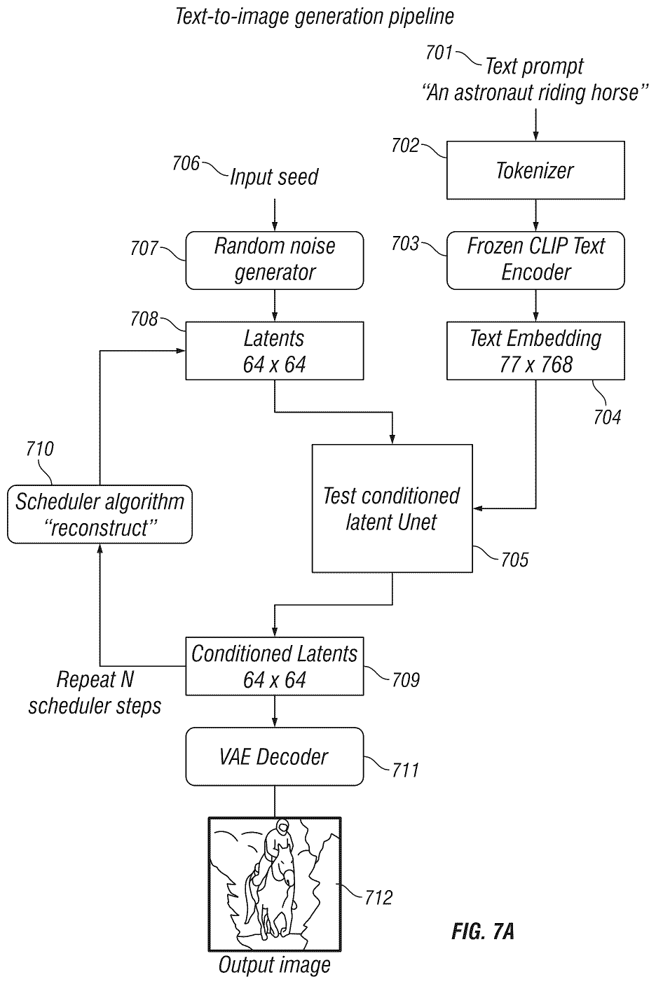

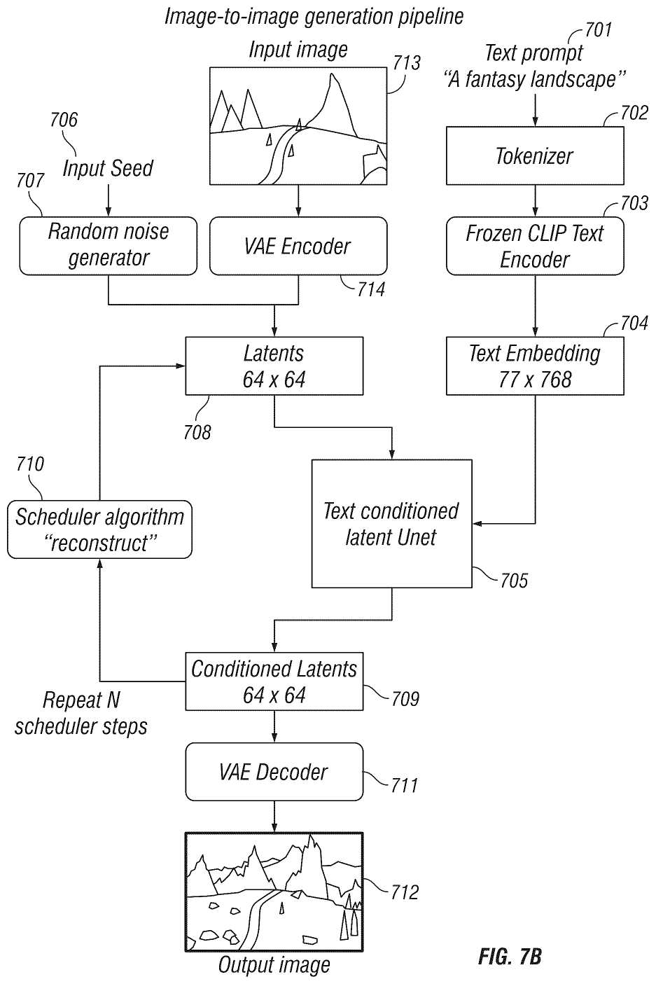

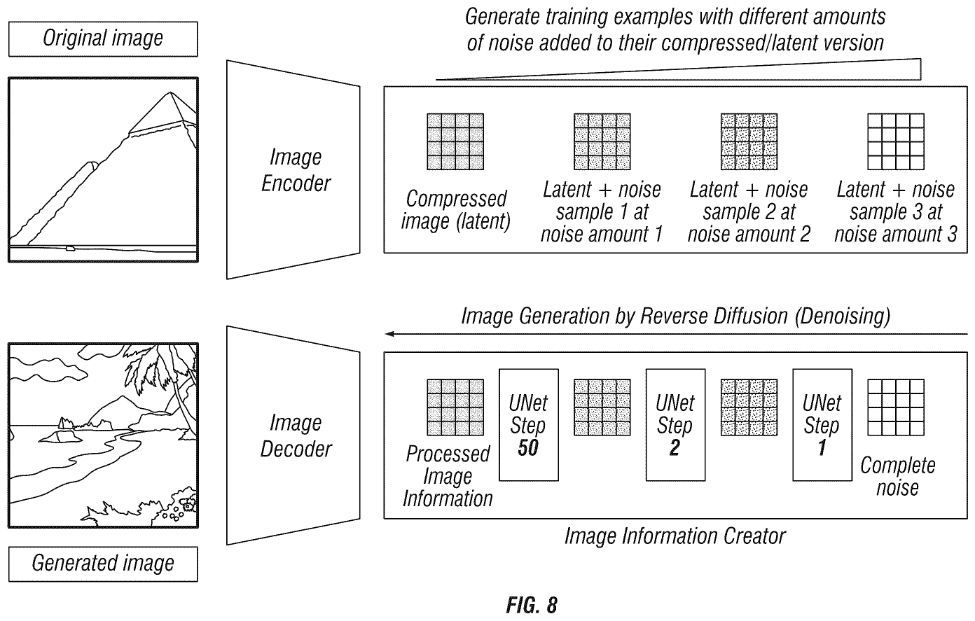

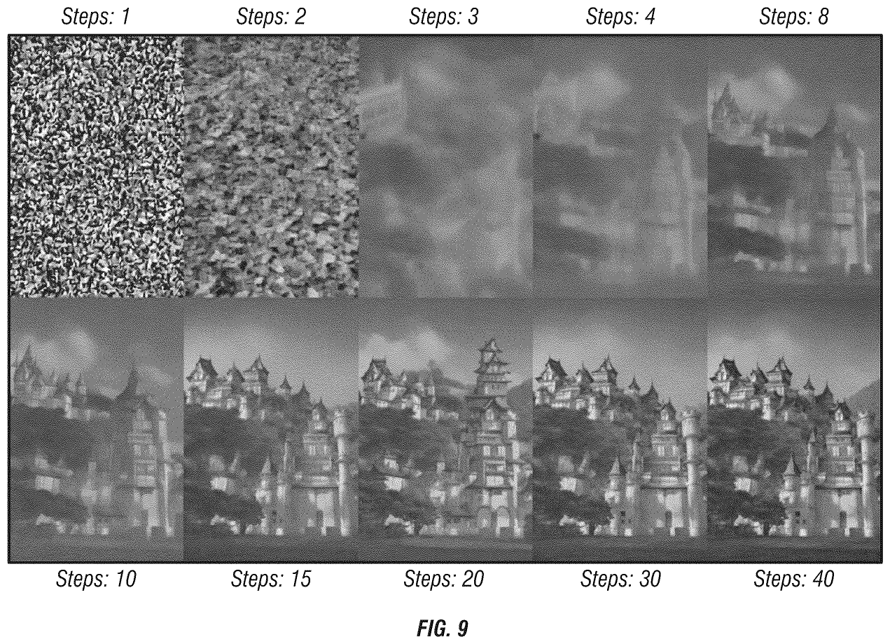

FIG. 7A represents the text to image generation pipeline need to produce the NFT. The system starts by taking two inputs, a text prompt 701 and an input seed 706 which eventually both feed into the text conditioned latent Unet 705. The text prompt 701 feeds into the tokenizer 702 and then flows into the frozen CLIP test encoder 703. This then feeds into text embedding module 704 and then into the text conditioned latent Unet 705. The input seed 706 flows into random noise generator 707 and then into a latent module 708. Finally, this then also flows into the text conditioned latent Unet 705. Once the process is completed, the outflowing information feeds through conditioned latents 709. From here, depending on the number of iterations the creator wants to endure, the data can be sent to the scheduler algorithm 710, into the latents module 708 again, and back into the text conditioned latent Unet module 705. Once the desired number of iterations has been completed, the data flow from the conditioned latents module 709, into the VAE decoder 711 wherein an image is finally output 712. The output image 712 is based on the text prompt 701 initially input and the input seed 706.

FIG. 7B represents a similar process to FIG. 7A, however FIG. 7B represents an image-to-image generation pipeline. This means, there is a third input for the system, an image. The input image 713 feeds into a VAE encoder 714 which then feeds into the same latents module 708 as seen in FIG. 7A. From here, the process is the same as FIG. 7A.

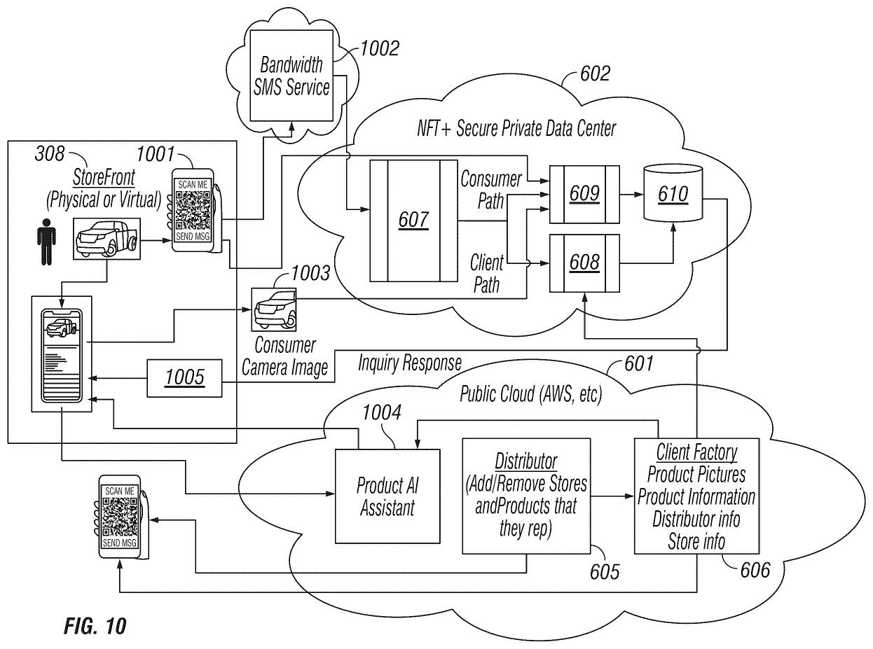

FIG. 10 illustrates a flow diagram representing the non-fungible token authentication architecture. The system begins at the storefront 308 which can be either virtual or physical. The potential consumer then scans the QR code embedded onto the good 1001 which then sends the data via a bandwidth SMS service 1002 and promptly feeds into the company selector API server 607. From here, the system splits into two paths, a consumer path and a client path. The consumer path feeds into the customer front end 609, where the data from the QR code scan 1001 is combined with a consumer camera image 1003. The client path feeds into the client front end 608. The client front end 608 receives data from the client factory 606 which is stored on a public cloud 601. A worm drive 610 in the secure private data center 620, receives the information from both the customer front end module 609 and the client front end module 608 to compare the indicium to stored data. Once the worm drive 610 determines the authenticity of the good, the consumer receives notification of the authentication's success 1005. The secure private data center 602 hosts the company selector API server 607, the customer front end 609, the client front end 608, and the worm drive 610. The public cloud 601 hosts the product AI assistant 1004, the distributor information 605, and the client factory information 606.

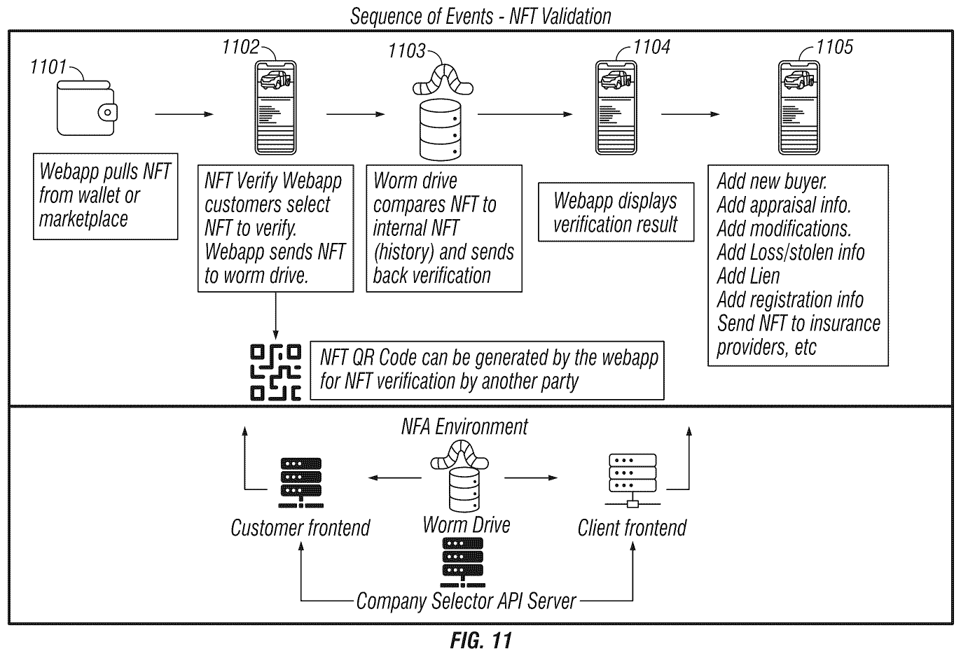

FIG. 11 is a flow diagram illustrating the process for validating an NFT to ensure authenticity. First, the web application pulls the NFT from a digital wallet or marketplace 1101 of the current owner of the NFT. The NFT Verify Webapp customers select which NFT to verify 1102, the NFT associated with the good which the prospective customer would purchase. The web application then sends the NFT to the worm drive 610. The worm drive 610 compares the NFT to internal NFT history and sends back verification 1103 to the consumer. The web application then displays the verification result 1104. After verification, the user of the web application can add a new buyer, add appraisal information, modifications, etc. 1105. These processes in FIG. 11 all take place in the secure private data center 602.

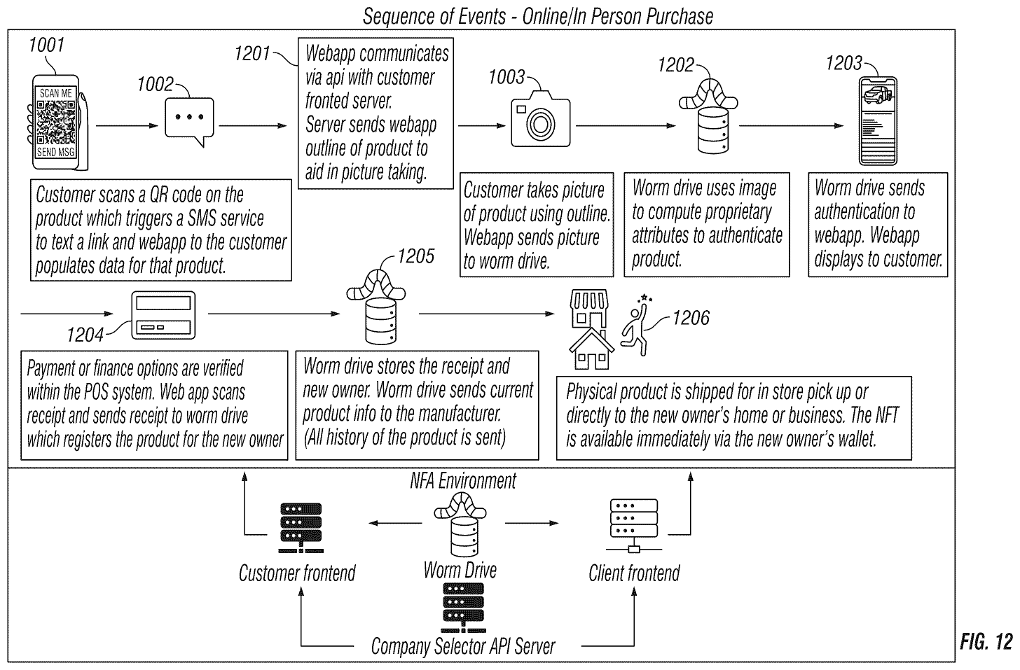

FIG. 12 is a flow diagram representing the process of an online or in person purchase using this system. First, the customer scans a QR code 1001 on the product which triggers an SMS service to text a link and web application 1002 to the customer which shows the customer data for that product 702. Webapp then communicates via the API with the customer fronted server. The server then a web application outline of the product to aid in picture taking 1201. The customer then takes a picture of the product creating a consumer camera image 1003 using the outline. Subsequently, the web application sends the picture to the worm drive 610. The worm drive 610 then uses this image to compute proprietary attributes to authenticate the product 1202. The worm drive 610 then sends the authentication to the web application wherein the web application displays the authenticity to the customer 1203. Once the good is authenticated, payment or finance options are verified within a point of sale (POS) system. The web application scans the receipt and sends the receipt to the worm drive which registers the product for the new owner 1204. The worm drive then stores the receipt and the new owner, then subsequently sends current product information to the manufacturer 1205. The physical product is then shipped for in store pickup or directly to the new owner's home or business. The NFT is available immediately via the new owner's digital wallet 1206.

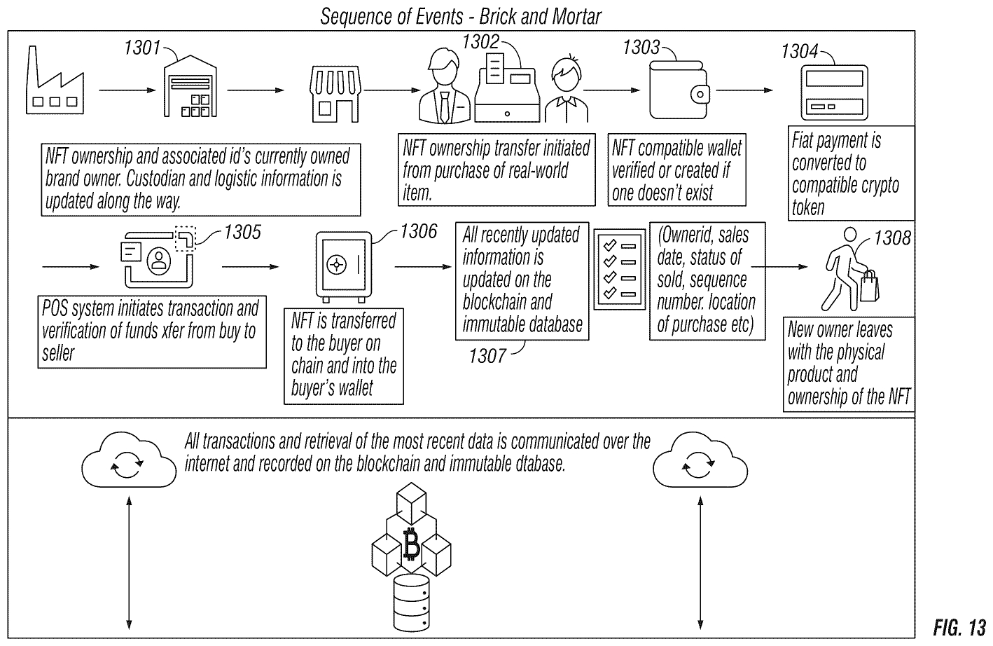

FIG. 13 illustrates the sequence of events of the NFT transfer during a brick-and-mortar purchase of a good. NFT ownership and associated identifications are first owned by the brand owner 1301. The NFT ownership transfer is initiated from the purchase of a real-world product 1302. An NFT compatible wallet then gets verified or created if one does not already exist 1303. Next, the fiat payment is converted to compatible cryptocurrency 1304, and the system initiates the transaction and verification of funds from the buyer to the seller 1305. The NFT is then transferred to the buyer on the blockchain and into the buyer's NFT compatible wallet 1306. During this process, all transactions and retrieval of the most recent data are communicated over the internet and recorded on the blockchain 1307. Finally, the new owner leaves with the physical product and ownership of the NFT 1308.

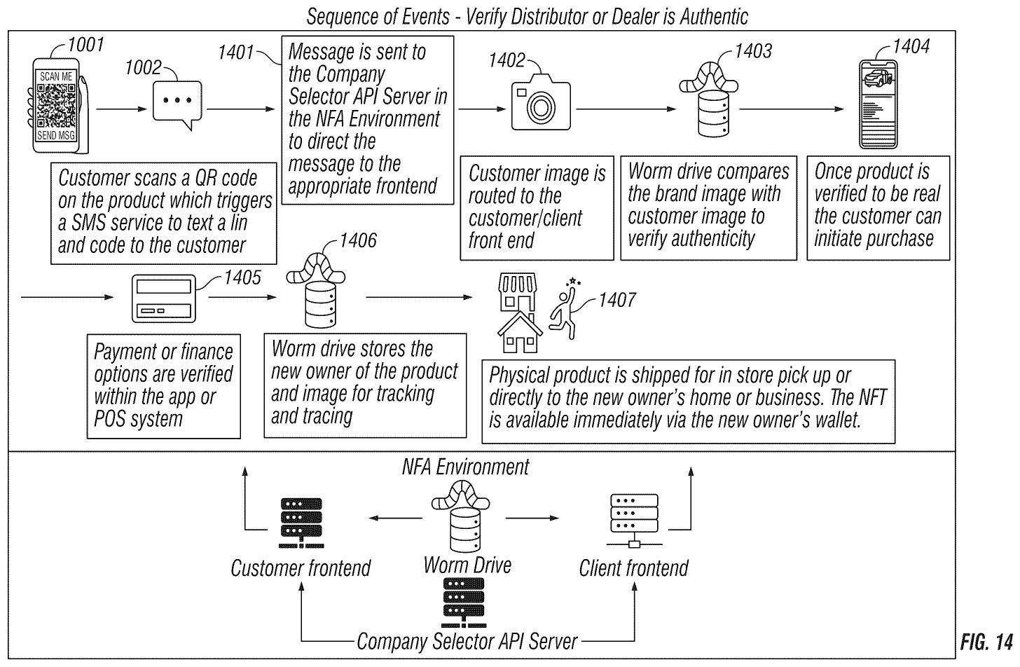

FIG. 14 is a flow diagram representing the process of authentication of a distributor or dealer of goods. The process begins when the customer scans a QR code 1001 on a product which then triggers an SMS service to message a link and code to the customer 1002. A message is then sent to the Company Selector API Server 607 in the NFA Environment to direct the message to the appropriate frontend 1401. A customer image is then routed to the customer/client front end 1402. A worm drive compares the brand image with the customer image to verify authenticity 1403. Once the product is verified, the customer can now initiate the purchase of the product 1404. Subsequently, the payment or finance options are verified within the application of POS system 1405. The worm drive then stores the information of the new owner for the product for tracking and tracing 1406. In the final step, the physical product is shopped for in store pick up or directly to the new owner's home or business. The NFT is available immediately via the new owner's wallet 1407.

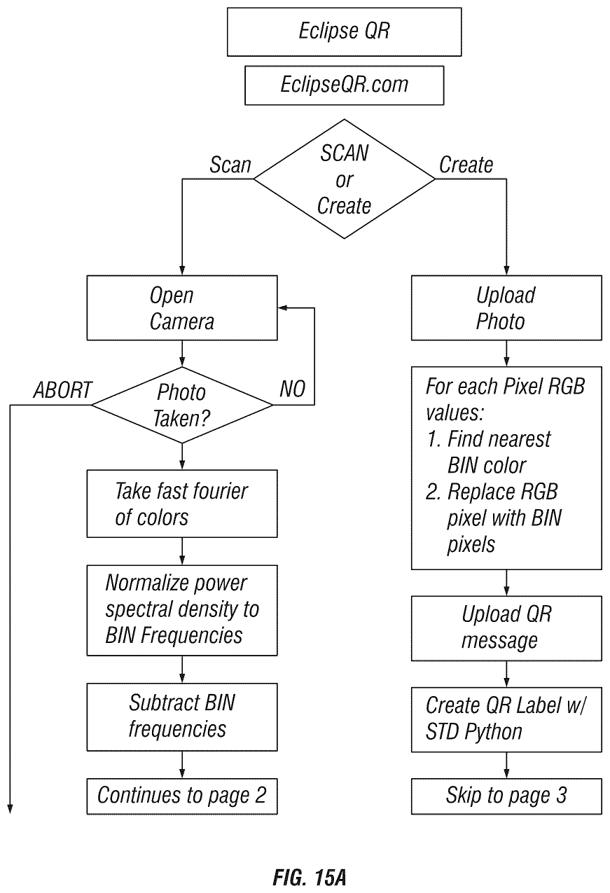

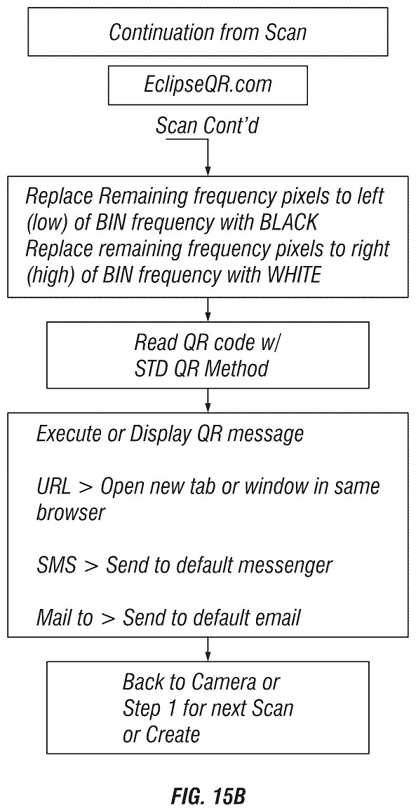

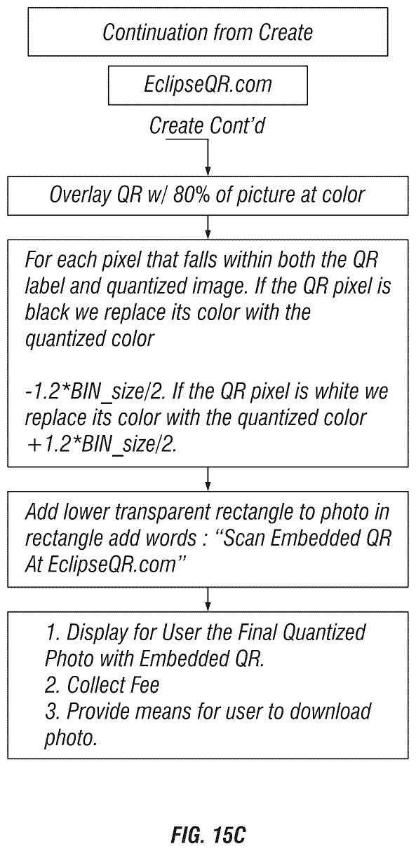

FIGS. 15A-15C provide an alternative method of embedding a QR code within an NFT, or in reverse, retrieving that QR code from within the NFT. To create the NFT, the following steps are used. First an image is created that will be the basis of the NFT. That image is uploaded and analyzed on a per pixel basis. Recall that the image might be a company logo. The image is granulated by assigning each pixel a value from a “bin.” For example, dark blues or dark greens might be assigned to the same particular bin based on the tonality of the original color. The original, or “RGB pixel” value is replaced with the bin pixel value. Next a QR code is provided that is specific to the item. The user then overlays the QR code with the granulated picture. Next, the QR code is aligned with over 80% of the quantized (or granulated) photo.

In the alternative, the QR code is placed in the bottom of the picture. This allows the system to train (sync) the colors from the first part of the picture with predefined colors. This accounts for shading, lighting, camera variations, etc. Next, the system is trained, when reading a picture, to compute the color error mean and standard deviation. Preferrably, a 2 times standard deviation is less than the QR code pixel color offset. Once trained, the system will replace all colors with the proper color, accounting for QR code pixel color offset. The system then removes all the original bin colors, leaving only the QR code. Likewise, the system replaces colors to the left of the original bin colors with black, and colors to the right of the original bin colors with white.

For each pixel that falls within both the QR label and quantized image; first if the QR pixel is black, then its color is replaced with the quantized color −1.2*BIN_size/2. If the QR pixel is white, then its color is replaced with the quantized color +1.2*BIN_size/2. Then, the user is shown the Final Quantized Photo with Embedded QR. The user, in most cases a brand owner, is provided the final quantized photo with the embedded QR code. It can be minted and stored on a blockchain.

A scan path must also be provided to allow a buyer to understand the provenance of the item. Usually this is accomplished with a cell phone camera that scans the now embedded QR code using a specialized program that reverses the embedding routine. A photo of a previously generated embedded QR is taken and analyzed using, for example a fast Fourier transform, to determine the dominant frequencies. Next, the power spectral density is normalized to BIN frequencies. The known dominant frequencies are aligned with the measured image frequencies. Shifting them up or down depending on the color BIN.

The BIN frequencies are subtracted. In other words, once aligned the system will subtract anything with the color BINs. Once complete, the color coded QR label is left. Then, remaining frequency pixels to left (low) of BIN frequency are replaced with BLACK. And remaining frequency pixels to right (high) of BIN frequency are replaced with WHITE. The remaining QR code then can be scanned and its link to an outside database is established. The provenance of the scanned item is then retrieved. While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure but should not be constrained by the headings set forth herein.

We claim:

1. A system for improved authenticity protection of an item sold to consumers comprising an indicium comprising a QR code nested with an NFT,
wherein the indicium is associated with the item,
wherein the indicium is linked to an information source that includes the provenance of the item.

2. The system of claim 1, wherein the QR code and/or NFT are generated by an artificial intelligence-enabled program.

3. The system of claim 1, wherein the QR code is embedded in the NFT such that one or more elements of the QR code are masked by the NFT.

4. The system of claim 3, wherein the QR code is embedded in the NFT using an embedding algorithm.

5. The system of claim 1, wherein the information source further comprises a profile associated with each item, wherein the profile includes one or more of item images, item information, distributor information, and store information.

6. The system of claim 1, further comprising a public cloud and secured private data server, wherein the public cloud hosts indicium generation and profile generation, and
wherein the secured private data server hosts a company selector API server, a customer front end, a client front end, and a worm drive.

7. The system of claim 6, wherein the worm drive is configured to:
store NFT data;
compare an image of the indicium to stored NFT data;
detect creation of a duplicate indicium; and
prevent linkage of the duplicate indicium to the information source.

8. The system of claim 7, wherein the image of the indicium is received through the customer front end.

9. The system of claim 1, wherein the indicium includes a trademark associated with the item.

10. A method for improving authenticity protection of an item sold to consumers comprising:
generating an indicium comprising a QR code nested with an NFT;
associating the indicium with the item; and
linking the indicium to an information source that includes the provenance of the item.

11. The method of claim 10, wherein generating an indicium comprises:
generating an NFT;
generating a QR code; and
embedding the NFT with a QR code such that one or more elements of the QR code are masked by the NFT.

12. The method of claim 10, wherein associating the indicium with the item comprises:
sending the indicium to a manufacturer and/or distributor in a public cloud;
generating a profile associated with each item; and
affixing the indicium to the item.

13. The method of claim 12, wherein the information source further comprises a profile associated with each item, wherein the profile includes one or more of item images, item information, distributor information, and store information.

14. The method of claim 10, wherein linking the indicium to an information source comprises sending the indicium and the associated profile to a secured private data server for storage.

15. The method of claim 10, further comprising receiving a request in response to a user using a QR code reader to read the QR code portion of the indicium.

16. The method of claim 15, further comprising presenting, to the user, an outline corresponding to the item associated with the QR code portion of the indicium.

17. The method of claim 16, further comprising receiving, from a user, an image of the indicium and the associated item.

18. The method of claim 17, further comprising comparing the image to the stored indicium and profile for authentication of the item.

19. The method of claim 18, further comprising presenting, to the user, an authentication notification.

20. The method of claim 19, further comprising updating the provenance of the item.
